(19) United States
(12) Patent Application Publication
(10) Pub. No.: US 2024/0320889 A1
(43) Pub. Date: Sep. 26, 2024

(54) METHOD AND SYSTEM FOR AUGMENTING DIGITAL HUMAN GESTURE

(71) Applicant: Sangmyung University Industry - Academy Cooperation Foundation, Seoul (KR)

(72) Inventors: Mincheol WHANG, Goyang-si (KR); Gyung Bin KIM, Seoul (KR); Ayoung CHO, Goyang-si (KR)

(21) Appl. No.: 18/124,711

(22) Filed: Mar. 22, 2023

(51) Int. Cl. G06T 13/00; G06T 7/246; G06T 7/73; G09B 5/02

(52) U.S. Cl. CPC G06T 13/00; G06T 7/246; G06T 7/73; G09B 5/02; G06T 2207/30201

(57) ABSTRACT

Provided are a method of and a system for augmenting a gesture of a digital human (DH). The method of augmenting a gesture of a digital human (DH) includes generating a DH by a character generating unit, capturing a real image of a real person by a camera, extracting keypoint coordinates of the real person from the real image by an image processing unit, determining an augmenting weight for the keypoint coordinates, and generating, by a DH controller, a DH augmented in comparison with keypoint movement of the real person by changing keypoint coordinates of the DH based on the augmented keypoint coordinates.

### BACKGROUND

### 1. Field

The disclosure relates to a method of generating a digital human in a virtual space, and more particularly, to a method and system for generating a digital human that augments and reflects a strength of a movement of a real person in real life.

### 2. Description of the Related Art

A digital human, which is an avatar having a human appearance, is expressed in a virtual space. As the digital humans are able to imitate real persons in a real space, a demand for expressing the real persons in the virtual space through the digital humans is increasing.

External factors considered to express the real persons with the digital humans include realistic modeling of the digital humans, imitated gestures, facial expressions, etc. A gesture of a digital human is a very important communication element accompanying human natural communicative expressions.

Like as gestures play an important role in human-to-human communication, gestures of digital humans have a crucial influence on communication in the virtual space as well. Research to effectively convey the intentions of real persons through these digital humans is desirable.

### SUMMARY

Provided are a method of and a system for improving a communication effect by a digital human.

Provided are a method of and a system for inducing effective communication and emotional transfer by a digital human by adjusting a size or an intensity of a gesture that is a non-verbal expression of a real person, to improve a communication effect.

Additional aspects will be set forth in part in the description which follows and, in part, will be apparent from the description, or may be learned by practice of the presented embodiments of the disclosure.

According to an aspect of the disclosure, a method of augmenting a gesture of a digital human includes generating a DH by a character generating unit, capturing a real image of a real person by a camera, extracting keypoint coordinates of the real person from the real image by an image processing unit, determining an augmenting weight for the human body keypoint coordinates, and generating, by a DH controller, a DH having a gesture augmented in comparison with a keypoint movement of the real person by changing keypoint coordinates of the DH based on the augmented keypoint coordinates.

According to one or more embodiments, the augmented keypoint coordinates may correspond to an upper body region including keypoints of the real person.

According to one or more embodiments, the augmented keypoint coordinates may be correlated to a particular part of a human body including the keypoint.

According to one or more embodiments, the generating of the DH may include
capturing the real image from the real person by the camera and modeling and generating the DH from the real image by the character generating unit.

According to one or more embodiments, the extracting of the keypoint coordinates may include extracting keypoint coordinates on a two-dimensional (2D) plane by an image analyzing unit and extracting three-dimensional (3D) keypoint coordinates (x, y, z) by inferring a third direction z that is perpendicular to the 2D plane by using a 3D analyzer.

According to one or more embodiments, the determining of the augmenting weight may include determining a weight for at least one keypoint coordinates among three x, y, and z coordinates in the 3D keypoint coordinates.

According to one or more embodiments, the DH may be a digital human tutor (DHT) guiding learning through an image, and a learning image may be displayed together with the DHT on a display.

According to another aspect of the disclosure, a system for generating a digital human (DH) includes a camera configured to photograph a real person, a character generating unit configured to generate a DH corresponding to the real person, an image analyzing unit configured to extract keypoint coordinates from a real image of the real person, obtained by the camera, an image generating unit configured to augment the keypoint coordinates of the real image and reflect the augmented keypoint coordinates as keypoint coordinates of the DH to generate a DH of an augmented gesture, and a display configured to display a target image including the DH.

According to one or more embodiments, the image analyzing unit may be further configured to extract two-dimensional (2D) keypoint coordinates, and the image generating unit may include a three-dimensional (3D) analyzer configured to extract 3D coordinates from the 2D keypoint coordinates.

In the system according to one or more embodiments, the image generating unit may be further configured to generate a target image including a background image for a particular purpose expressed as a background together with the DH.

The 3D analyzer may be provided by a deep learning model executed by a computer.

The system according to the disclosure may be applied to generation of a digital human tutor (DHT) existing in a virtual space.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a flowchart for describing a concept of a method of augmenting a gesture, according to the disclosure;

FIG. 2 is a flowchart of a method of augmenting a gesture according to one or more embodiments;

FIG. 3 is a flowchart of a method of extracting a face of a real person in a method of augmenting a gesture according to one or more embodiments;

FIG. 4 shows several keypoints extracted from a real person in a method of augmenting a gesture according to one or more embodiments;

FIG. 5 shows an original image of a digital human (DH) to which a method of augmenting a gesture according to a one or more embodiments is not applied;

FIGS. 6 to 8 show images of a result from augmentation by x, y, and z coordinates of a hand part of a DH in a method of augmenting a gesture according to one or more embodiments;

FIG. 9 shows an image of a result a state where coordinates of a hand are augmented in x, y, and z directions, in a method of augmenting a gesture according to one or more embodiments;

FIG. 10 shows a comparison between a DH before augmentation and a DH after completion of augmentation in a method of augmenting a gesture according to one or more embodiments; and

FIG. 11 is a block diagram of a DH generating system according to one or more embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, embodiments of the disclosure will be described in detail with reference to the accompanying drawings. However, embodiments of the disclosure may be modified in various other forms, and the scope of the disclosure should not be construed as being limited due to the embodiments described in detail below. It is preferable that the embodiments of the disclosure be interpreted as being provided in order to more completely describe the disclosure to those of ordinary skill in the art.

Identical symbols refer to the same elements from beginning to end. Furthermore, various elements and regions in the drawings are schematically drawn. Accordingly, the disclosure is not limited by the relative size or spacing drawn in the accompanying drawings.

The terms, first, second, etc., may be used to describe various components, but the components are not limited by these terms. These terms are used to distinguish one component from another component. For example, a first component may be named as a second component without departing from the right scope of the disclosure, and on the other hand, the second component may be named as the first component.

The term used herein is used to describe particular embodiments, and is not intended to limit the disclosure. Singular forms include plural forms unless apparently indicated otherwise contextually. Herein, it should be understood that the expression “include”, “have”, or the like used herein is to indicate the presence of features, numbers, steps, operations, components, parts, or a combination thereof described in the specifications, and does not preclude the presence or addition of one or more other features, numbers, steps, operations, components, parts, or a combination thereof.

Unless defined otherwise, all terms used herein have the same meaning as commonly understood by those of ordinary skill in the art, including technical and scientific terms. In addition, commonly used terms as defined in the dictionary should be construed as having a meaning consistent with their meaning in the context of the relevant technology, and should not be construed as an excessively formal meaning unless explicitly defined herein.

When a certain embodiment may be implemented otherwise, a particular process order may be performed differently from the order described. For example, two processes described in succession may be performed substantially simultaneously, or may be performed in an order reverse to the order described.

A digital human (DH), which is an object generated by computer programming, may be an avatar having a human appearance, and may have a property for various human characteristics, in which the property of the object may be controlled by a method, a function, etc.

The DH may be simply used for a metaverse or may be applied as an avatar of a real tutor in an on-line learning system, etc. Recently, as a demand for untact services has increased with the spread of virus infection, a disinhibition effect lacking empathy has emerged as an important issue due to increasing indirect communication via online rather than face-to-face communication. This is considered as an important issue due to difficulties in empathic communication between tutors and learners in online learning situations. Thus, to improve emphatic interaction between a tutor and a learner, it is necessary to remotely recognize a learner's attitude and adjust an appropriate tutor's response or feedback accordingly. When the tutor imitates various responses of the learner, the learner feels like the learner is similar to the tutor, such that social bonds are increased and thus the learner tends to empathize more with the tutor. Thus, a technique for recognizing a facial expression or reaction of the learner in real time and causing a virtual tutor, a digital human tutor to react to the facial expression or reaction or to imitate the facial expression may induce empathy from the learner and improve the effectiveness of learning.

The disclosure relates to a method of augmenting a gesture of a DH to more effectively convey a non-verbal expression of a DH used for various purposes, and a system employing the method.

The method of augmenting a gesture of a DH according to the disclosure is performed by a computer-based image processing system with an attached video camera. The image processing system may include a character generating unit based on software and/or hardware processing an image, an image processing unit, a digital human controller, etc., and as external input devices, a camera photographing a real person, a display, a keyboard, a mouse, etc., for control and information input of a computer.

More specifically, a system for generating a DH according to the disclosure may include a camera 11 configured to capture a real person, a character generating unit 12 configured to generate a DH corresponding to the real person, an image analyzing unit 13 configured to extract keypoint coordinates from a real image of the real person, obtained by the camera 11, an image generating unit 14 configured to augment the keypoint coordinates of the real image and reflect the same to keypoint coordinates of the DH to generate a DH of an augmented gesture, and a display 15 configured to display a target image including the DH.

A method of augmenting a gesture of a human tutor (HT) according to the disclosure implemented by the foregoing system will be described below.

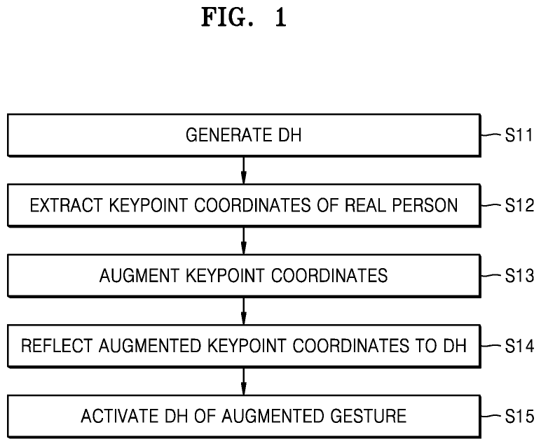

FIG. 1 is a flowchart of a method of augmenting a gesture of a DH according to one or more embodiments.

A method of generating a DH having an augmented gesture according to the disclosure may generate a DH in the form of an avatar in operation S11 and extract keypoint coordinates by photographing a real person corresponding to the DH in operation S12. The keypoint coordinates may be increased or reduced to be transformed in operation S13. The augmented keypoint coordinates may be reflected to the DH to highlight a pose of the DH in comparison to a gesture of the real person in operation S15, and the DH may be activated in operation S15.

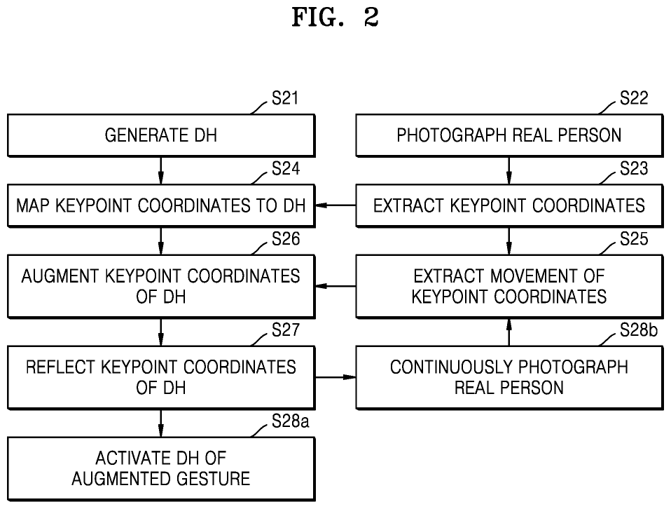

FIG. 2 is a detailed flowchart of a method of augmenting a gesture of a DH, with reference to which a detailed method of augmenting a gesture of a DH will be described.

### <Operation S21>

This operation is an operation of generating or forming a DH object. This process may be performed together with photographing of the real person. This may artificially form an appearance of the DH, but according to another embodiment, an appearance of the real person may be imitated and may be overlaid on the appearance of the DH. In this case, a DH model generating unit may photograph a face of the real person and then extract facial characteristics from the photographed face of the real person to apply them as appearance characteristics of the DH. As an actual DH generator for this end, a program “Character Creator” may be used.

A feature that characterizes the appearance of the real person may be extracted in the manner described below.

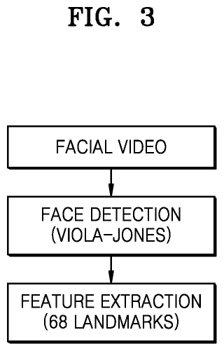

FIG. 3 shows a process of detecting the facial characteristics of the real person in a method of generating a DH.

### A. Face Detection

A facial region is detected from a captured image of a real person actually photographed.

### B. Facial Landmark Detection

In this process, a face landmark that defines in a facial action coding system (FACS) using an existing method is detected from the detected facial region. In this case, 68 landmarks such as positions of an eye, a nose, a mouth, an eyebrow, a jaw, etc., of the real person may be detected to secure the facial characteristics of the real person as data.

### C. Face Alignment

The landmark data may be reflected to facial characteristics of the HT, thus generating an HT of a full-body or half-body image resembling a face of the real person.

### <Operation S22>

After the HT (object) is generated as described above, a full body or a half body of the real person is photographed.

### <Operation S23>

Keypoint coordinates are extracted from the full-body or half-body image of the real person. There are about 18 keypoints of a human body, and for more natural gesture expression, it may be desirable to extract 18 keypoint coordinates. For extraction of the keypoint coordinates, various methods may be used, and herein, a deep learning model based on machine learning may be applied. As known deep learning models, there may be cmu, mobilenet_thin, r mobilenet_v2_large, mobilenet_v2_small, tf-pose-estimation, openpose, vnect, etc. Herein, keypoint coordinate extraction may be a DH initialization process for corresponding a DH model to keypoints of a real person.

### <Operation S24>

In this operation, the keypoint coordinates extracted in the foregoing process may be 1:1 mapped to keypoints of the DH generated in the foregoing process. That is, coordinates of the keypoints of the DH and the keypoint coordinates of the real person may be 1:1 correlated with each other.

### <Operation S25>

In this operation, keypoint coordinates moved along movement of a person in the real person image may be extracted at specific frame intervals.

In this operation, extraction of the keypoint coordinates may apply cmu, mobilenet_thin, mobilenet_v2_large, mobilenet_v2_small, tf-pose-estimation, openpose, vnect, etc., as the deep learning model described above.

### <Operation S26>

This operation is a coordinate augmenting operation for augmenting a gesture where the gesture of the real person is greatly highlighted and emphasized in the range thereof. The increase or reduction of the keypoint coordinates may be performed with respect to the originally extracted two-dimensional (2D) coordinates. According to another embodiment of the disclosure, the 2D coordinates (x, y) may be transformed into three-dimensional (3D) coordinates (x, y, z) to implement a realistic active gesture. The 2D coordinates (x, y) may be coordinates in a 2D video image plane, and a third coordinate “z” added thereto may be a coordinate in a direction perpendicular to the video image plane. With this transformation, a coordinate in the z direction may be added to the originally extracted 2D coordinates (x, y), thus constituting 3D coordinates expressed as (x, y, z). Herein, the coordinates may include a particular region of the human body, e.g., a hand region, and a position of the hand may be changed up and down, left and right, and back and forth by coordinate transformation.

3D pose estimation may be applied to such 3D transformation, and algorithms for such transformation may include mutual PnP, lifting from the deep (Denis Tome, Chris Russell, Lourdes Agapito, 2017), etc.

The number of 3D keypoint coordinates increases over 18 that is the number of input 2D coordinates, for example, to 54 that is the maximum number of 3D keypoint coordinates. In this case, the augmentation of the gesture may include increasing or decreasing coordinates or augmenting an angle on coordinates.

### <Operation S27>

By applying the coordinates augmented in the foregoing process, e.g., augmented 2D or 3D keypoint coordinates to a DH model (object), an augmented gesture may be implemented in the DH.

### <Operations S28a and S28b>

The DH having the foregoing augmented gesture may be activated by being implemented on a target video, and at the same time, a full body of the real person may be continuously photographed to detect a gesture change of the next real person, and the process may be returned to <Operation S25> to repeat the above-described routine, thereby implementing or obtaining a target image or a target DH.

In short, a main course of the disclosure is a process of, after initially generating the DH object, mapping keypoint characteristics of the DH object to keypoints of the real person to initialize the DH, and then continuously recognizing and augmenting the keypoint coordinates of the real person and applying the keypoint coordinates to the DH object for activation.

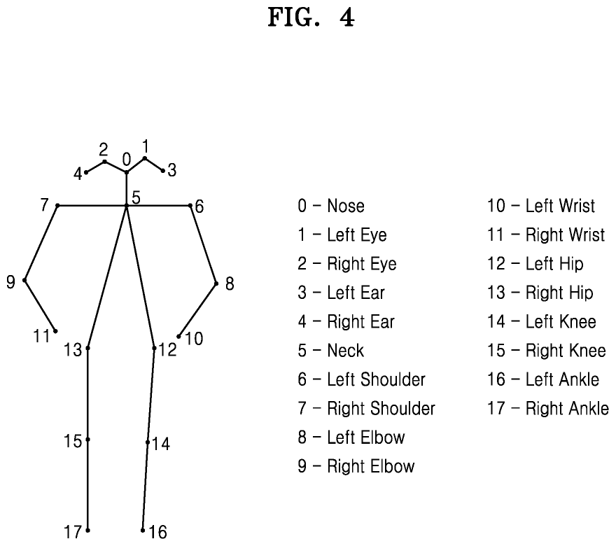

The keypoints mentioned in the disclosure may be classified into 18 keypoints as shown in FIG. 4.

Referring to FIG. 4, the maximum number of keypoints extracted from the real person may be 18 including a nose, eyes, ears, a mouth of a face, and a neck, as well as limbs and shoulder keypoints.

To implement a natural pose or gesture in the keypoints, all the keypoints have to be used.

The following description will be made of a DH of an actually implemented augmented gesture.

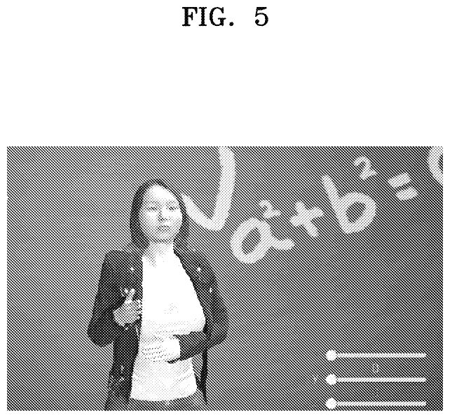

FIGS. 5 to 8 illustrate a DH in which gesture augmentation is not performed and a DH augmented per coordinates.

FIG. 5 illustrates a tutor guiding learning through a video, i.e., a digital human tutor (DHT). In the video of FIG. 5, the DHT passively places both hands on the inside of the upper body.

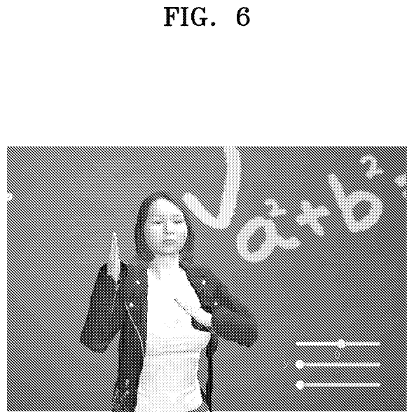

FIG. 6 shows an example where the gesture of the DH is partially augmented and an angle in the x direction is augmented in the 3D coordinates.

As can be from comparison between FIG. 5 and FIG. 6, FIG. 6 shows the more active and energetic hand gesture than FIG. 5.

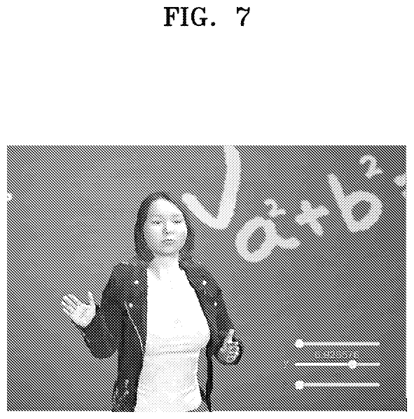

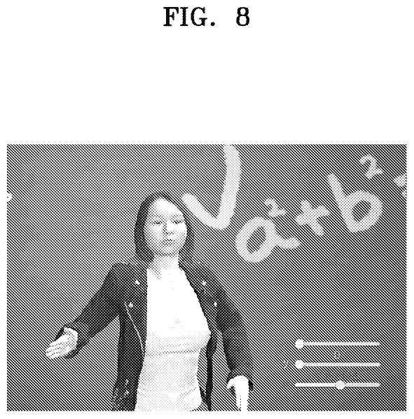

FIG. 7 shows an example where an angle in the y direction is augmented in the 3D coordinates of the DH, and FIG. 8 shows an example where an angle in the y direction is augmented and shows augmentation in the z direction.

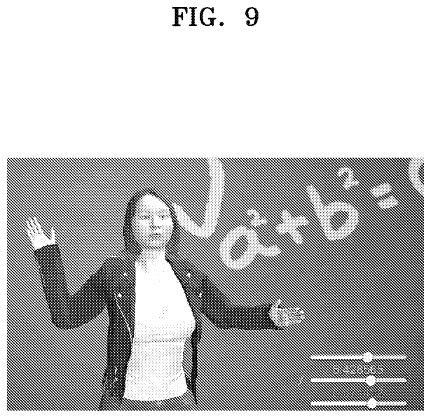

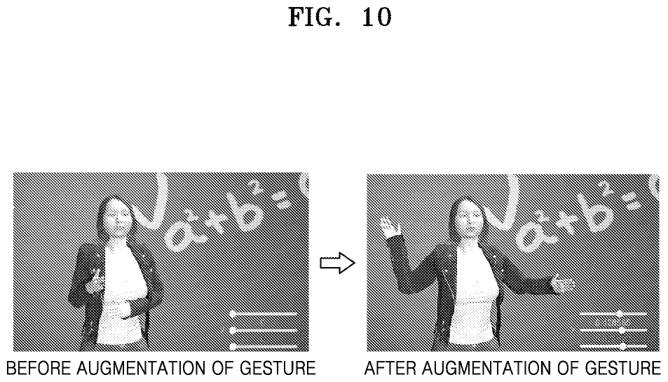

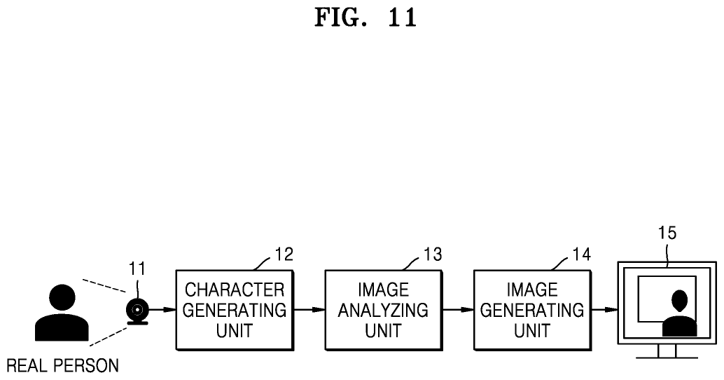

FIG. 9 shows a comparison between a DH (left side) before augmentation and a DH (right side) after augmentation of coordinate angles in all of the x, y, and z directions.

As comparatively shown in FIG. 9, a pose after augmentation is more active and dynamic than that before augmentation. This shows that the non-verbal expressions of the DH are very strongly expressed.

Such video transformation may employ a video controller in various program forms, e.g., software ‘Unity’.

In Unity, movement of each keypoint may be augmented to a value in a range of 0 to about 10 of a slider UI provided in Unity, and augmentation of each keypoint may be such that a keypoint angle is increased or reduced in a specific range, e.g., from about 50 degrees to about-50 degrees. As shown in FIGS. 6 to 9, when augmentation of an arm part gesture is desired, an image processor may select a keypoint corresponding to an arm part and select x, y, and z angles of the keypoint to augment an angle in a range of 0 to about 10.

The DH generated in the foregoing way may be applied to various fields, and herein, may be applied as a DHT in an image learning system. In the image learning system, the non-verbal expression expressed through body gestures as well as the tutor's verbal expression may be effectively conveyed to the learner, thereby increasing the efficiency of learning. The transfer of such non-verbal expressions may also be usefully used in the virtual world.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of augmenting a gesture of a digital human (DH), the method comprising:
generating a DH by a character generating unit;
capturing a real image of a real person by a camera;
extracting keypoint coordinates of the real person from the real image by an image processing unit;
determining an augmenting weight for the keypoint coordinates; and
generating, by a DH controller, a DH augmented in comparison with a keypoint movement of the real person by changing keypoint coordinates of the DH based on the augmented keypoint coordinates.

2. The method of claim 1, wherein the augmented keypoint coordinates correspond to an upper body region comprising keypoints of the real person.

3. The method of claim 1, wherein the generating of the DH comprises:
capturing the real image from the real person by the camera; and
modeling and generating the DH from the real image by the character generating unit.

4. The method of claim 1, wherein the extracting of the keypoint coordinates comprises:
extracting keypoint coordinates on a two-dimensional (2D) plane by an image analyzing unit; and
extracting three-dimensional (3D) keypoint coordinates (x, y, z) by inferring a third direction z that is perpendicular to the 2D plane by using a 3D analyzer.

5. The method of claim 2, wherein the extracting of the keypoint coordinates comprises:
extracting keypoint coordinates on a two-dimensional (2D) plane by an image analyzing unit; and
extracting three-dimensional (3D) keypoint coordinates (x, y, z) by inferring a third direction z that is perpendicular to the 2D plane by using a 3D analyzer.

6. The method of claim 4, wherein the determining of the augmenting weight comprises determining a weight for at least one keypoint coordinates among three x, y, and z coordinates in the 3D keypoint coordinates.

7. The method of claim 4, wherein the determining of the augmenting weight comprises determining a weight for at least one keypoint coordinates among three x, y, and z coordinates in the 3D keypoint coordinates.

8. The method of claim 1, wherein the determining of the augmenting weight comprises determining a weight for at least one keypoint coordinates among three x, y, and z coordinates in the 3D keypoint coordinates.

9. The method of claim 2, wherein the determining of the augmenting weight comprises determining a weight for at least one keypoint coordinates among three x, y, and z coordinates in the 3D keypoint coordinates.

10. The method of claim 1, wherein the DH is a digital human tutor (DHT) guiding learning through an image, and a learning image is displayed together with the DHT on a display.

11. A system for augmenting a gesture of a digital human (DH), the system performing the method of claim 1 and comprising:
a camera configured to photograph a real person;
a character generating unit configured to generate a DH corresponding to the real person;
an image analyzing unit configured to extract keypoint coordinates from a real image of the real person obtained by the camera;
an image generating unit configured to augment the keypoint coordinates of the real image and reflect the augmented keypoint coordinates as keypoint coordinates of the DH to generate a DH of an augmented gesture; and
a display configured to display a target image comprising the DH.

12. The system of claim 11, wherein the augmented keypoint coordinates correspond to an upper body region comprising keypoints of the real person.

13. The system of claim 11, wherein the image analyzing unit is further configured to extract two-dimensional (2D) keypoint coordinates, and the image generating unit comprises a three-dimensional (3D) analyzer configured to extract 3D coordinates from the 2D keypoint coordinates.

14. The system of claim 12, wherein the image analyzing unit is further configured to extract two-dimensional (2D) keypoint coordinates, and the image generating unit comprises a three-dimensional (3D) analyzer configured to extract 3D coordinates from the 2D keypoint coordinates.

15. The system of claim 11, wherein the image generating unit is further configured to generate a target image comprising a background image for a particular purpose expressed as a background together with the DH.

16. The system of claim 12, wherein the image generating unit is further configured to generate a target image comprising a background image for a particular purpose expressed as a background together with the DH.

17. The system of claim 13, wherein the image generating unit is further configured to generate a target image comprising a background image for a particular purpose expressed as a background together with the DH.

18. The system of claim 14, wherein the image generating unit is further configured to generate a target image comprising a background image for a particular purpose expressed as a background together with the DH.
